(19) United States
(12) Patent Application Publication
(10) Pub. No.: US 2026/0192696 A1
(43) Pub. Date: Jul. 9, 2026

(54) BATTERY CHARGING SYSTEM AND BATTERY CHARGING METHOD

(71) Applicant: LITE-ON SINGAPORE PTE. LTD., Singapore (SG)

(72) Inventor: Pravin Ignatius FALCAO, Singapore (SG)

(21) Appl. No.: 19/231,612

(22) Filed: Jun. 9, 2025

Related U.S. Application Data
(60) Provisional application No. 63/741,493, filed on Jan. 3, 2025.
(60) Provisional application No. 63/760,679, filed on Feb. 20, 2025.

(51) Int. Cl. B60L 53/63; B60L 53/10; B60L 53/62; B60L 53/80; B60L 58/12; B60L 58/16

(52) U.S. Cl. CPC B60L 53/63; B60L 53/11; B60L 53/62; B60L 53/80; B60L 58/12; B60L 58/16; B60L 2260/54

(57) ABSTRACT

A battery charging method is for charging several batteries communicatively coupled to a charging station, which are further communicatively coupled to an edge controller. The battery charging method comprises the following steps. A battery swap in several banks storing the batteries is detected, by an edge computation of the edge controller. A battery demand and an energy demand associated with the batteries and the charging station are forecasted in several forecast windows, by the edge computation of the edge controller. The charging station is controlled to operate at several stages by the edge computation of the edge controller, wherein the charging station transitions from a current stage to a next stage among the stages based on the battery swap, the battery demand and the energy demand. A charging power for charging the batteries corresponding to the stages is determined, by the edge computation of the edge controller.

This application claims the benefits of U.S. provisional application Ser. No. 63/741,493 filed Jan. 3, 2025 and U.S. provisional application Ser. No. 63/760,679 filed Feb. 20, 2025, the disclosures of which are incorporated by reference herein in their entirety.

### TECHNICAL FIELD

The present disclosure relates to a charging mechanism for batteries of electrical vehicles, and particularly relates to a battery charging system and a battery charging method based on a smart staging mechanism.

### BACKGROUND

New energy has been widely employed in daily life, including various types of electrical energy. Electrical vehicles are equipped with batteries to well employ the electrical energy, and battery swap stations are widely established to support the charging for the batteries.

For conventional battery swap stations, a “static charging mechanism” is usually utilized, in which batteries are charged statically and sequentially. In the static charging mechanism, each of the batteries will be continuously charged until a predefined value of state-of-charging (SOC) is reached. For example, a battery will be continuously charged to reach the SOC of 90%, i.e., charging for the battery will not be stopped before reaching the SOC of 90%.

The traditional static charging mechanism does not consider battery demand and energy demand. Accordingly, peak energy cost will be hugely consumed if each battery is statically charged to the predefined value of SOC. Furthermore, if chargers of the battery swap station statically utilize fast charging without considering battery demand and energy demand, unnecessary energy will be hugely consumed.

On the other hand, chargers of the battery swap station may alternatively utilize normal charging or slow charging, so as to achieve low energy cost under peak battery demand and energy availability. However, in this situation, it may encounter un-availability of batteries, which may unfortunately lead to a great deterioration on the experience of customers (i.e., drivers of electrical vehicles. If lacking an efficient control mechanism on battery charging which well considers battery demand and energy demand, all batteries in the battery swap station cannot be suitably charged at the same time.

In view of the above issues, it is desirable to have an improved charging mechanism, which can efficiently and flexibly charge all the batteries in the swap station and best suit both the battery demand and the energy demand.

### SUMMARY

According to one embodiment of the present disclosure, a battery charging system is provided. The battery charging system comprises a battery swap station and an edge controller. The battery swap station has a charging station communicatively coupled to the batteries. The edge controller is communicatively coupled to the battery swap station and configured to perform an edge computation, where the edge computation comprises the following actions. A detection of a battery swap in a plurality of banks storing the batteries. A forecast of a battery demand and an energy demand associated with the batteries and the charging station in a plurality of forecast windows. A control of the charging station to operate at a plurality of stages, wherein the charging station transitions from a current stage to a next stage among the stages based on the battery swap, the battery demand and the energy demand. A determination of a charging power for charging the batteries corresponding to the stages.

According to another embodiment of the present disclosure, a battery charging method is provided. The battery charging method is for charging a plurality of batteries which are communicatively coupled to a charging station, and the charging station is communicatively coupled to an edge controller. The battery charging method comprises the following steps. A battery swap in a plurality of banks storing the batteries is detected, by an edge computation of the edge controller. A battery demand and an energy demand associated with the batteries and the charging station are forecasted in a plurality of forecast windows, by the edge computation of the edge controller. Charging station is controlled to operate at a plurality of stages by the edge computation of the edge controller, wherein the charging station transitions from a current stage to a next stage among the stages based on the battery swap, the battery demand and the energy demand. A charging power for charging the batteries corresponding to the stages is determined, by the edge computation of the edge controller.

### BRIEF DESCRIPTION OF THE DRAWINGS

FIG. 1 is a block diagram of a battery charging system 2000 according to an embodiment of the present disclosure.

FIG. 2 is a block diagram of the edge controller 1200 in the battery charging system 2000 of FIG. 1.

FIG. 3 is a schematic diagram illustrating the operation of the forecast processing engine 1201 in the edge controller 1200 of FIG. 2.

FIG. 4 is a flow diagram of a main flow of a battery charging method according to an embodiment of the present disclosure.

FIG. 5A is a flow diagram of a main flow of the smart staging mechanism in the battery charging method.

FIG. 5B is a flow diagram of the stage S0 performed in step S512 of FIG. 5A.

FIG. 6A is a flow diagram of the stage S1 in the smart staging mechanism.

FIGS. 6B_1 and 6B_2 are flow diagrams of the stage S2A in the smart staging mechanism.

FIGS. 6C_1 and 6C_2 are flow diagrams of the stage S2B in the smart staging mechanism.

FIG. 6D is a flow diagram of the stage S3 in the smart staging mechanism.

FIG. 6E is a flow diagram of the stage S4 in the smart staging mechanism.

FIG. 6F is a flow diagram of the stage S5 in the smart staging mechanism.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

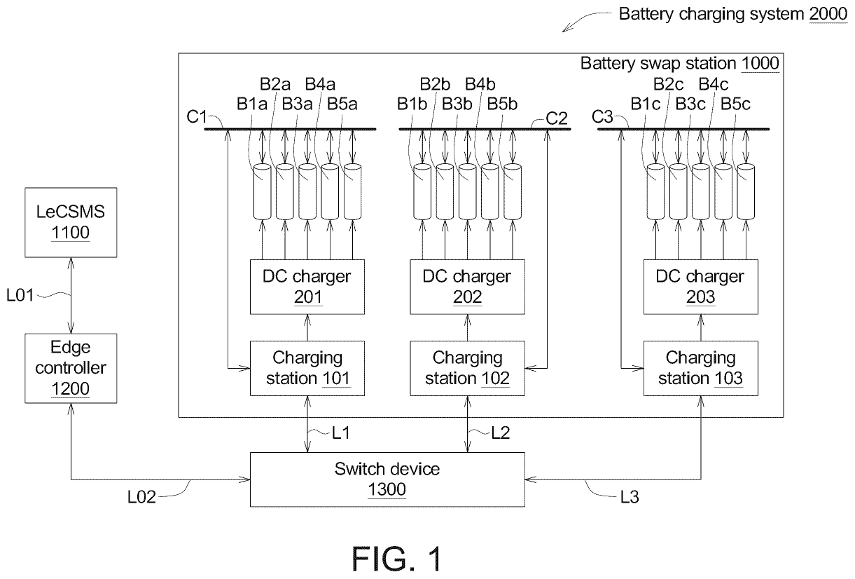

FIG. 1 is a block diagram of a battery charging system 2000 according to an embodiment of the present disclosure. The battery charging system 2000 is an artificial-intelligence (AI) based operating platform, which may perform smart charging and smart staging applied to batteries of electrical vehicles, based on AI algorithms. As shown in FIG. 1, the battery charging system 2000 includes a battery swap station 1000, a module of Cyber-Security-Management-System (LeCSMS) 1100 (referred to as a “LeCSMS module” 1100), an edge controller 1200 and a switch device 1300. The LeCSMS module 1100 is a central computing device which may be disposed in a cloud server and function to perform a central computation. Furthermore, the edge controller 1200 is an edge computing device which may be disposed according to an Internet-of-Things (IoT) infrastructure and hence referred to as an “IoT edge”. The edge controller 1200 may function to perform an edge computation (i.e., de-centralized computation) which is aligned with the central computation performed by the LeCSMS module 1100.

The LeCSMS module 1100 is communicatively coupled to the edge controller 1200 through a link L01. Furthermore, the edge controller 1200 is communicatively coupled to the switch device 1300 through a link L02. In one example, the link L01 is a Message-Queuing-Telemetry-Transport (MQTT) link, and the link L02 is an Open-Charge-Point-Protocol (OCPP) link with an “OCPP2. Lite web-socket”.

The battery swap station 1000 may include at least one charging station. In the example of FIG. 1, the battery swap station 1000 includes three charging stations 101, 102 and 103, and each of the charging stations 101, 102 and 103 may support at least one direct-current (DC) charger to charge several batteries of the electrical vehicle. In the example of FIG. 1, the charging station 101 supports a DC charger 201, and the DC charger 201 functions to charge five batteries B1a~B5a. Furthermore, the charging station 102 supports a DC charger 202 which functions to charge other five batteries B1b~B5b. Likewise, the charging station 103 supports a DC charger 203 for charging still other five batteries B1c~B5c.

The charging stations 101, 102 and 103 are communicatively coupled to the switch device 1300 through the links L1, L2 and L3 respectively. Each of the links L1, L2 and L3 is, e.g., an OCPP link, which is similar to the link L02 between the switch device 1300 and the edge controller 1200. In addition, each of the charging stations 101, 102 and 103 is communicatively coupled to corresponding ones of the batteries B1a~B5a, B1b~B5b and B1c~B5c. For example, the charging station 101 is communicatively coupled to the batteries B1a~B5a through a link C1, the charging station 102 is communicatively coupled to the batteries B1a~B5a through a link C2, and the charging station 103 is communicatively coupled to the batteries B1a~B5a through a link C3. Each of the links C1, C2 and C3 is, e.g., a Controller-Area-Network (CANBUS) link.

The edge controller 1200 may cooperate with the charging stations 101, 102 and 103 in the battery swap station 1000 to perform an edge computation which may be aligned with the central computation performed by the LeCSMS module 1100. The edge computation may include a smart charging mechanism and a smart staging mechanism with which the charging stations 101, 102 and 103 can well control the DC chargers 201, 202 and 203 to suitably charge the corresponding batteries B1a~B5a, B1b~B5b and B1c~B5c in a flexible and efficient manner, such that energy cost can be reduced and customer's satisfaction can be enhanced.

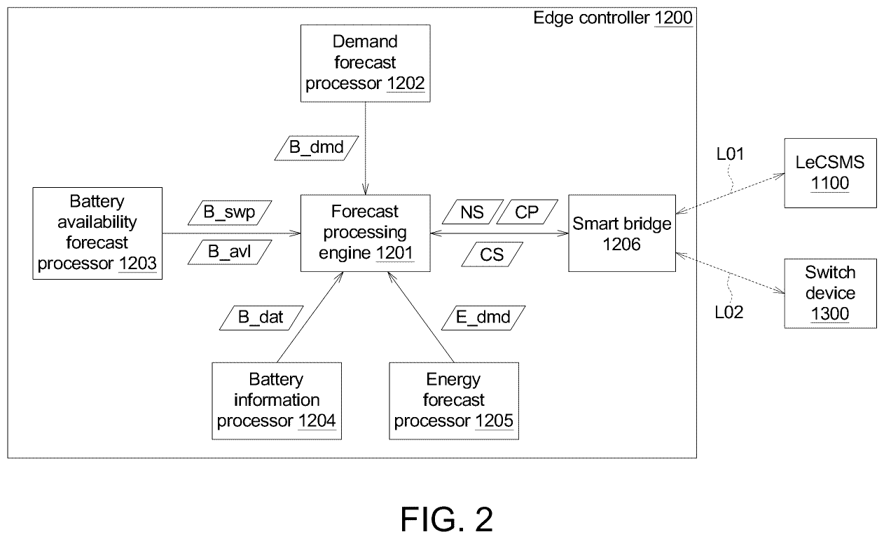

FIG. 2 is a block diagram of the edge controller 1200 in the battery charging system 2000 of FIG. 1. The edge controller 1200 may include several hardware (or software) modules for performing the smart charging mechanism. As shown in FIG. 2, the hardware (or software) modules in the edge controller 1200 may include a forecast processing engine 1201, a demand forecast processor 1202, a battery availability forecast processor 1203, a battery information processor 1204, an energy forecast processor 1205 and a smart bridge 1206. When implemented by the hardware, each of the forecast processing engine 1201, the demand forecast processor 1202, the battery availability forecast processor 1203, the battery information processor 1204, the energy forecast processor 1205 and a smart bridge 1206 may be a hardware processor, (e.g., a central control unit (CPU), a micro control unit (MCU) or a digital signal processor (DSP)), an integrated circuit (e.g., an application specific integrated circuit (ASIC)), or a system circuit fabricated on a circuit board.

The smart bridge 1206 may be communicatively coupled to the LeCSMS module 1100 and the switch device 1300 through the links L01 and L02 respectively. Through a communicating connection formed by the smart bridge 1206 and the link L02, edge computations performed by the forecast processing engine 1201, the demand forecast processor 1202, the battery availability forecast processor 1203, the battery information processor 1204 and the energy forecast processor 1205 can be aligned with the central computation by the LeCSMS module 1100.

The operation of the edge controller 1200 will be described taking the five batteries B1a~B5a (corresponding to the charging station 101 in the battery swap station 1000) as an example. The battery information processor 1204 is communicatively coupled with the batteries B1a~B5a through the smart bridge 1206 and the link L02, and hence the battery information processor 1204 may obtain a battery data B_dat of each of the batteries B1a~B5a. The battery data B_dat may include a state-of-charging (SOC), a state-of-health (SOH) and a temperature of each of the batteries B1a~B5a. The battery information processor 1204 may read the battery data B_dat from the batteries B1a~B5a for each of predefined time periods (e.g., one minute), in a real-time manner.

The battery availability forecast processor 1203 may retrieve the SOC in the battery data B_dat obtained by the battery information processor 1204. Then, the battery availability forecast processor 1203 may obtain a total number of “available batteries” among the batteries B1a~B5a, based on the SOC of each of the batteries B1a~B5a. In one example, the battery availability forecast processor 1203 determines one of the batteries B1a~B5a as “available” when its SOC is greater than or equal to a first threshold (e.g., 50%) or greater than or equal to a second threshold (e.g., 80%). For every minute, the battery availability forecast processor 1203 may count the number of batteries which are available (i.e., “available batteries”), among the batteries B1a~B5a. Furthermore, the battery availability forecast processor 1203 may compute an average value for the numbers of “available batteries” (which have been counted in the past minutes) over a longer time period, e.g., an hour. Therefore, the battery availability forecast processor 1203 may obtain battery availability B_avl for every hour (which is also referred to as “hourly battery availability”). The battery availability B_avl indicates an average number of “available batteries” among the batteries B1a~B5a.

Furthermore, the battery availability forecast processor 1203 may count the number of swaps for the batteries B1a~B5a for every minute, in a real-time manner. Then, the battery availability forecast processor 1203 may compute an average value for the numbers of swaps over a longer predefined time period, (e.g., an hour). The average number of swaps of the batteries B1a~B5a over the predefined time period is referred to as a battery swap B_swp.

Moreover, the demand forecast processor 1202 may compute a battery demand B_dmd. In one example, the battery demand B_dmd is a ratio of the battery swap B_swp with respect to the battery availability B_avl, as shown in equation (1):

$$B\_dmd = B\_swp / B\_avl \qquad ( 1 )$$

The battery demand B_dmd may have three levels “low”, “medium” and “high”, as shown in Table 1. When the battery demand B_dmd has a value less than 50%, it corresponds to the level “low” with a score “0”. Furthermore, the value of the battery demand B_dmd between 50% and 70% may correspond to the level “medium” with a score “1”, while the value of the battery demand B_dmd greater than 70% may correspond to the level “high” with a score “2”.

TABLE 1
battery demand B_dmd

| | | |
|---|---|---|
| low | 0 | <50% |
| medium | 1 | 50%~70% |
| high | 2 | >70% |

In addition, the energy forecast processor 1205 may compute an energy demand E_dmd. In one example, the energy demand E_dmd is a ratio of forecasted energy with respect to actual total available energy of the charging station 101, which is also equal to a ratio of forecasted power with respect to total power, as shown in equations (2-1) and (2-2):

$$E\_dmd = forecasted energy / actual total available energy \qquad ( 2 - 1 )$$

$$E\_dmd = forecasted power / total power \qquad ( 2 - 2 )$$

In one example, the charging station 101 may provide a maximum power of 100 KW, and 90% of the maximum power (which is equal to 90 KW) may be taken as a maximum limit. Then, the actual total available energy provided by the charging station 101 is 90 KW.

The energy demand E_dmd may have two levels “low” and “high”, as shown in Table 2. The value of the energy demand E_dmd less than or equal to 60% may correspond to the level “low” with a score “0”, while the value of the energy demand E_dmd greater than 60% may correspond to the level “high” with a score “1”.

TABLE 2
energy demand E_dmd

| | | |
|---|---|---|
| low | 0 | =<60% |
| high | 1 | >60% |

The demand forecast processor 1202 and the energy forecast processor 1205 may evaluate the battery demand B_dmd and the energy demand E_dmd based on windows over time periods, as shown in Table 3. Twenty-four hours for one day may be divided as eight windows FW1~FW8, where each of the windows FW1~FW8 may have a time length of three hours. In the example, of Table 3, the current window FW1 is an interval from 12 AM to 3 AM, the next window FW2 is an interval from 3 AM to 6 AM, and the further next window FW3 is an interval from 6 AM to 9 AM, etc. That is, the current window FW1, the next window FW2 and the further next window FW3 are successive time periods.

TABLE 3
forecast windows

| FW 1 | FW 2 | FW 3 | FW 4 | FW 5 | FW 6 | FW 7 | FW 8 |
|---|---|---|---|---|---|---|---|
| 12 AM-3 AM | 3 AM-6 AM | 6 AM-9 AM | 9 AM-12 PM | 12 PM-3 PM | 3 PM-6 PM | 6 PM-9 PM | 9 PM-12 AM |

Based on the above, in the edge controller 1200, the availability forecast processor 1203 may generate the battery availability B_avl and the battery swap B_swp. Furthermore, the battery information processor 1204 may obtain the battery data B_dat. Moreover, the energy forecast processor 1205 may generate the energy demand E_dmd. In addition, the demand forecast processor 1202 may generate the battery demand B_dmd. Then, the battery data B_dat, the battery availability B_avl, the battery swap B_swp, the energy demand E_dmd and the battery demand B_dmd are provided to the forecast processing engine 1201.

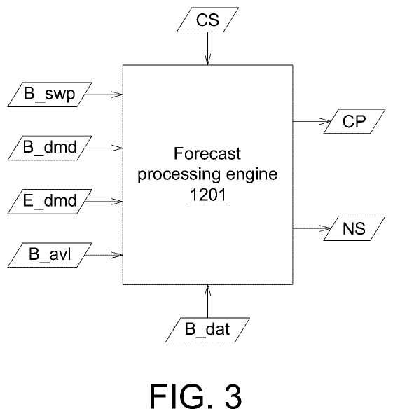

FIG. 3 is a schematic diagram illustrating the operation of the forecast processing engine 1201 in the edge controller 1200 of FIG. 2. The forecast processing engine 1201 receives several input data, including the the battery data B_dat, the battery availability B_avl, the battery swap B_swp, the energy demand E_dmd and the battery demand B_dmd (as described in the former paragraphs by reference to FIG. 2). Furthermore, the input data of the forecast processing engine 1201 also includes a current stage CS. Based on the above input data, the forecast processing engine 1201 is configured to perform a forecast mechanism to generate two output data, including a charging power CP and a next stage NS.

The definition of the charging power CP is a level of power for the charging station 101 provides to the batteries B1a~B5a. The charging power CP may have four levels “slow charging”, “normal charging”, “fast charging (F)” and “turbo charging (T)”, as shown in Table 4. Furthermore, the level “slow charging” may include two sub-levels “S1” and “S2”, and the level “normal charging” may include two sub-levels “N1” and “N2”.

The sub-levels “S1” and “S2” of “slow charging” correspond to powers of 0.3×C and 0.4×C, where the notation “C” represents a battery capacity of the corresponding one of the batteries B1a~B5a. The sub-levels “N1” and “N2” of “normal charging” correspond to powers of 0.5×C and 0.6×C. In addition, the level “F” of “fast charging” correspond to a power of 0.7×C, while the level “T” of “turbo charging” correspond to a power of 1.0×C.

TABLE 4
charging power CP

| | | | |
|---|---|---|---|
| slow-1 charging | S1 | 0.3 | C |
| slow-2 charging | S2 | 0.4 | C |
| normal-1 charging | N1 | 0.5 | C |
| normal-2 charging | N2 | 0.6 | C |
| fast charging | F | 0.7 | C |
| turbo charging | T | 1 | C |

More particularly, the edge controller 1200 in conjunction with the battery swap station 1000 may perform a smart staging mechanism, in which the charging stations 101~103 may dynamically change among several stages, including stages S0, S1, S2A, S2B, S3, S4, S5 and SI. The current stage CS (one of the input data of the forecast processing engine 1201) is one of the stages S0, S1, S2A, S2B, S3, S4, S5 and SI at which the charging station currently operates. Furthermore, the next stage NS (one of the output data of the forecast processing engine 1201) is a target stage changed from the current stage CS. Table 5 shows characteristics of the stages S0, S1, S2A, S2B, S3, S4, S5 and SI, with the charging station 101 and the corresponding batteries B1a~B5a taken as an example.

More particularly, the stage S0 is a static stage where a sequential charging is performed on the batteries B1a~B5a with a constant charging power. Furthermore, the stages S1, S2A, S2B and S3 are basic stages, where the stage S2B may be referred to as “aux stage”. Among the basic stages S1, S2A, S2B and S3, the stage S1 is an initial stage, and the stages S2A, S2B and S3 are demand-driven stages based on the demand forecast. Moreover, the stages S4 and S5 are premium stages, which are energy-driven stages based on a premium member and an available energy. In addition, the stage SI is an idle stage.

TABLE 5

| | Basic stages | | | | | Premium stages | | |
|---|---|---|---|---|---|---|---|---|
| | Initial | Initial | Demand driven | | | Energy driven | | |
| battery | SOC | priority | stage | stage | stage | stage | stage | stage |
| bank | % | stage S1 | S2A | S2B | S3 | S4 | S5 | SI |
| B1 | 10 | S1-P3 | S2-P1 | S2-P3 | | S4-P1 | | idle |
| B2 | 12 | S1-P2 | S2-P2 | S2-P4 | | S4-P2 | | idle |
| B3 | 21 | S1-P1 | | | S3-P1 | | S5-P1 | idle |
| B4 | 5 | | S2-P3 | S2-P1 | S3-P2 | | S5-P2 | idle |
| B5 | 8 | | S2-P4 | S2-P2 | S3-P3 | | S5-P3 | idle |

| | | | | | | |
|---|---|---|---|---|---|---|
| Total available | 3 batteries | 3 batteries | 3 batteries | 0 batteries | 0 batteries | 0 batteries |
| batteries after | 3 batteries | 2 batteries | 2 batteries | 5 batteries | 3 batteries | 0 batteries |
| stages | 0 batteries | 0 batteries | 0 batteries | 0 batteries | 2 batteries | 5 batteries |

The batteries B1a~B5a may have priorities P1, P2, P3 and P4 which are scheduled based on the current SOC and SOH (i.e., the SOC and SOH at a current period) of the batteries B1a~B5a. In the example of Table 5, the batteries B1a~B5a have initial SOCs (i.e., the SOCs at an initial period) of 10%, 12%, 21%, 5% and 8% respectively. In stage S1, initially, the battery B1a has a priority P3, the battery B2a has a priority P2, and the battery B3a has a priority P1. Only three batteries B1a, B2a and B3a will be charged at a SOC equal to the first threshold (e.g., 50%).

Furthermore, in stage S2A, the battery B1a has a priority P1, the battery B2a has a priority P2, the battery B4a has a priority P3, and the battery B5a has a priority P4. Three batteries B3a, B4a and B5a will be charged at a SOC greater than or equal to the first threshold, and the other two batteries B1a and B2a will be charged at a SOC greater than or equal to a second threshold. The second threshold is, e.g., 80%, which is greater than the first threshold.

Thereafter, in stage S2B, the battery B1a has a priority P3, the battery B2a has a priority P4, the battery B4a has a priority P1, and the battery B5a has a priority P2. The batteries B3a, B4a and B5a will be charged at a SOC greater than or equal to the first threshold, and the batteries B1a and B2a will be charged at a SOC greater than or equal to the second threshold.

Moreover, in stage S3, the batteries B3a, B4a and B5a have priorities P1, P2 and P3. All of the five batteries B1a~B5a have SOC will be charged at a SOC greater than or equal to the second threshold. Thereafter, in stage S4, the batteries B1a and B2a have priorities P1 and P2 and will be charged at a SOC equal to a third threshold. The third threshold is 100%, and hence the SOC equal to the third threshold may be referred to as “full SOC”. On the other hand, the batteries B3a, B4a and B5a have SOC will be charged at a SOC greater than or equal to the second threshold.

Thereafter, in stage S5, the batteries B3a, B4a and B5a have priorities P1, P2 and P3. All of the five batteries B1a~B5a will be charged at a SOC equal to the third threshold. In addition, in stage SI, each of the five batteries B1a~B5a has an idle state.

Transitions of the stages S1, S2A, S2B, S3, S4, S5 and SI may be carried out based on the battery swap B_swp, the battery demand B_dmd and energy demand E_dmd. The battery swap B_swp is detected in a real-time manner. On the other hand, the battery demand B_dmd and energy demand E_dmd are evaluated based on forecast windows (the forecast windows are listed in Table 3). Transitions of the stages S1, S2A, S2B, S3, S4, S5 and SI are totally performed based on a first operating table, and the first operating table may be divided into several sub-tables, e.g., Tables 6-1 to 6-5 as the following.

Firstly, referring to Table 6-1 which shows stage transitions for the current stage CS of stage S1. If the battery swap B_swp is not detected (notified as “0”) and battery demand B_dmd has a score “0” in the current window FW 1, then the next stage NS will be stage S2A. If battery demand B_dmd has scores “1” or “2” in the current window FW 1, then the next stage NS will be stage S2B. On the other hand, if the battery swap B_swp is detected (notified as “1”), then the next stage NS will be stage S1 (i.e., the stage will not transit). In the example of Table 6-1, not any immediate state change occurs.

TABLE 6-1

| Input | | | | | | | | Output | |
|---|---|---|---|---|---|---|---|---|---|
| | | FW 1 | | FW 2 | | FW 3 | | | Immediate |
| CS | B_swp | B_dmd | E_dmd | B_dmd | E_dmd | B_dmd | E_dmd | NS | stage change |
| S1 | 0 | 0 | 0 | X | X | X | X | S2A | NO |
| S1 | 0 | 0 | 1 | X | X | X | X | S2A | NO |
| S1 | 0 | 1 | 0 | X | X | X | X | S2B | NO |
| S1 | 0 | 2 | 0 | X | X | X | X | S2B | NO |
| S1 | 0 | 1 | 1 | X | X | X | X | S2B | NO |
| S1 | 0 | 2 | 1 | X | X | X | X | S2B | NO |
| S1 | 1 | 0 | 0 | X | X | X | X | S1 | NO |
| S1 | 1 | 0 | 1 | X | X | X | X | S1 | NO |
| S1 | 1 | 1 | 0 | X | X | X | X | S1 | NO |
| S1 | 1 | 2 | 0 | X | X | X | X | S1 | NO |
| S1 | 1 | 1 | 1 | X | X | X | X | S1 | NO |
| S1 | 1 | 2 | 1 | X | X | X | X | S1 | NO |

Then, referring to Table 6-2 which shows stage transitions for the current stage CS of stages S2A and S2B. If the battery swap B_swp is not detected (notified as “0”), then the next stage NS will be stage S3. On the other hand, if the battery swap B_swp is detected (notified as “1”), then the next stage NS will be stage S1. The above transitions of the stage does not consider the battery demand B_dmd and the energy demand E_dmd in the next window FW 2 and the further next window FW 3.

TABLE 6-2

| Input | | | | | | | | Output | |
|---|---|---|---|---|---|---|---|---|---|
| | | FW 1 | | FW 2 | | FW 3 | | | Immediate |
| CS | B_swp | B_dmd | E_dmd | B_dmd | E_dmd | B_dmd | E_dmd | NS | stage change |
| S2A | 0 | 0 | 0 | X | X | X | X | S3 | NO |
| S2A | 0 | 0 | 1 | X | X | X | X | S3 | NO |
| S2A | 0 | 1 | 0 | X | X | X | X | S3 | NO |
| S2A | 0 | 2 | 0 | X | X | X | X | S3 | NO |
| S2A | 0 | 1 | 1 | X | X | X | X | S3 | NO |
| S2A | 0 | 2 | 1 | X | X | X | X | S3 | NO |
| S2A | 1 | 0 | 0 | X | X | X | X | S1 | NO |
| S2A | 1 | 0 | 1 | X | X | X | X | S1 | NO |
| S2A | 1 | 1 | 0 | X | X | X | X | S1 | NO |
| S2A | 1 | 2 | 0 | X | X | X | X | S1 | YES |
| S2A | 1 | 1 | 1 | X | X | X | X | S1 | NO |
| S2A | 1 | 2 | 1 | X | X | X | X | S1 | YES |
| S2B | 0 | 0 | 0 | X | X | X | X | S3 | NO |
| S2B | 0 | 0 | 1 | X | X | X | X | S3 | NO |
| S2B | 0 | 1 | 0 | X | X | X | X | S3 | NO |
| S2B | 0 | 2 | 0 | X | X | X | X | S3 | NO |
| S2B | 0 | 1 | 1 | X | X | X | X | S3 | NO |
| S2B | 0 | 2 | 1 | X | X | X | X | S3 | NO |
| S2B | 1 | 0 | 0 | X | X | X | X | S1 | NO |
| S2B | 1 | 0 | 1 | X | X | X | X | S1 | NO |
| S2B | 1 | 1 | 0 | X | X | X | X | S1 | NO |
| S2B | 1 | 2 | 0 | X | X | X | X | S1 | YES |
| S2B | 1 | 1 | 1 | X | X | X | X | S1 | NO |
| S2B | 1 | 2 | 1 | X | X | X | X | S1 | YES |

Then, referring to Table 6-3 which shows stage transitions for the current stage CS of stage S3. If the battery swap B_swp is detected (notified as “1”), then the next stage NS will be stage S1. On the other hand, if the battery swap B_swp is not detected (notified as “0”), then the next stage NS will be stage S4 or the idle stage SI, depending on the the battery demand B_dmd and the energy demand E_dmd in the current window FW 1. When the energy demand E_dmd in the current window FW 1 has a score “0”, the next stage NS will be stage S4. Alternatively, when the energy demand E_dmd in the current window FW 1 has a score “1”, the next stage NS will be stage SI.

TABLE 6-3

| Input | | | | | | | | Output | |
|---|---|---|---|---|---|---|---|---|---|
| | | FW 1 | | FW 2 | | FW 3 | | | Immediate |
| CS | B_swp | B_dmd | E_dmd | B_dmd | E_dmd | B_dmd | E_dmd | NS | stage change |
| S3 | 0 | 0 | 0 | X | X | X | X | S4 | NO |
| S3 | 0 | 0 | 1 | X | X | X | X | SI | NO |
| S3 | 0 | 1 | 0 | X | X | X | X | S4 | NO |
| S3 | 0 | 2 | 0 | X | X | X | X | S4 | NO |
| S3 | 0 | 1 | 1 | X | X | X | X | SI | NO |
| S3 | 0 | 2 | 1 | X | X | X | X | SI | NO |
| S3 | 1 | 0 | 0 | X | X | X | X | S1 | NO |
| S3 | 1 | 0 | 1 | X | X | X | X | S1 | NO |
| S3 | 1 | 1 | 0 | X | X | X | X | S1 | YES |
| S3 | 1 | 2 | 0 | X | X | X | X | S1 | YES |
| S3 | 1 | 1 | 1 | X | X | X | X | S1 | YES |
| S3 | 1 | 2 | 1 | X | X | X | X | S1 | YES |

Then, referring to Table 6-4 which shows stage transitions for the current stage CS of stage S4. If the battery swap B_swp is detected (notified as “1”), then the next stage NS will be stage S1. On the other hand, if the battery swap B_swp is not detected (notified as “0”), the next stage NS will be stage S5 when the energy demand E_dmd in the current window FW 1 has a score “0”, and the next stage NS will be stage SI when the energy demand E_dmd in the current window FW 1 has a score “1”.

TABLE 6-4

| Input | | | | | | | | Output | |
|---|---|---|---|---|---|---|---|---|---|
| | | FW 1 | | FW 2 | | FW 3 | | | Immediate |
| CS | B_swp | B_dmd | E_dmd | B_dmd | E_dmd | B_dmd | E_dmd | NS | stage change |
| S4 | 0 | 0 | 0 | X | X | X | X | S5 | NO |
| S4 | 0 | 0 | 1 | X | X | X | X | SI | NO |
| S4 | 0 | 1 | 0 | X | X | X | X | S5 | NO |
| S4 | 0 | 2 | 0 | X | X | X | X | S5 | NO |
| S4 | 0 | 1 | 1 | X | X | X | X | SI | NO |
| S4 | 0 | 2 | 1 | X | X | X | X | SI | NO |
| S4 | 1 | 0 | 0 | X | X | X | X | S1 | YES |
| S4 | 1 | 0 | 1 | X | X | X | X | S1 | YES |
| S4 | 1 | 1 | 0 | X | X | X | X | S1 | YES |
| S4 | 1 | 2 | 0 | X | X | X | X | S1 | YES |
| S4 | 1 | 1 | 1 | X | X | X | X | S1 | YES |
| S4 | 1 | 2 | 1 | X | X | X | X | S1 | YES |

Then, referring to Table 6-5 which shows stage transitions for the current stage CS of stage S5. If the battery swap B_swp is detected (notified as “1”) the next stage NS will be stage S1, otherwise, if the battery swap B_swp is not detected (notified as “0”) the next stage NS will be stage SI; no matter the scores of the battery demand B_dmd and the energy demand E_dmd in the current window FW 1, the next window FW 2 and the further next window FW 3.

TABLE 6-5

| Input | | | | | | | | Output | |
|---|---|---|---|---|---|---|---|---|---|
| | | FW 1 | | FW 2 | | FW 3 | | | Immediate |
| CS | B_swp | B_dmd | E_dmd | B_dmd | E_dmd | B_dmd | E_dmd | NS | stage change |
| S5 | 0 | 0 | 0 | X | X | X | X | SI | NO |
| S5 | 0 | 0 | 1 | X | X | X | X | SI | NO |
| S5 | 0 | 1 | 0 | X | X | X | X | SI | NO |
| S5 | 0 | 2 | 0 | X | X | X | X | SI | NO |
| S5 | 0 | 1 | 1 | X | X | X | X | SI | NO |
| S5 | 0 | 2 | 1 | X | X | X | X | SI | NO |
| S5 | 1 | 0 | 0 | X | X | X | X | S1 | YES |
| S5 | 1 | 0 | 1 | X | X | X | X | S1 | YES |
| S5 | 1 | 1 | 0 | X | X | X | X | S1 | YES |
| S5 | 1 | 2 | 0 | X | X | X | X | S1 | YES |
| S5 | 1 | 1 | 1 | X | X | X | X | S1 | YES |
| S5 | 1 | 2 | 1 | X | X | X | X | S1 | YES |

Furthermore, the forecast processing engine 1201 determines the charging power CP for at least one of the DC chargers 201~203 of the charging stations 101~103 based on the second operating table. The second operating table may be divided into two sub-tables, e.g., Tables 7-1 and 7-2 as the following.

Firstly, referring to Table 7-1 which shows the determination of the charging power CP when the battery demand B_dmd and the energy demand E_dmd both have a score “0” in the current window FW 1.

If the battery demand B_dmd in the next window FW 2 has a score “0”, the charging power CP will be “normal-1 charging” when the energy demand E_dmd in the further next window FW 3 has a score “1” and “normal-2 charging” when the energy demand E_dmd in the further next window FW 3 has a score “0”.

If the battery demand B_dmd in the next window FW 2 has a score “1”, the charging power CP will be “normal-1 charging” when the energy demand E_dmd in the next window FW 2 has a score “0” and “normal-2 charging” when the energy demand E_dmd in the next window FW 2 has a score “1”.

If the battery demand B_dmd in the next window FW 2 has a score “2”, the charging power CP will be “fast charging” when the energy demand E_dmd in the next window FW 2 has a score “0” and “turbo charging” when the energy demand E_dmd in the next window FW 2 has a score “1”.

TABLE 7-1

| Input | | | | | | Output |
|---|---|---|---|---|---|---|
| FW 1 | | FW 2 | | FW 3 | | charging |
| B_dmd | E_dmd | B_dmd | E_dmd | B_dmd | E_dmd | power CP |
| 0 | 0 | 0 | 0 | 0 | 0 | S2 |
| 0 | 0 | 0 | 0 | 0 | 1 | N1 |
| 0 | 0 | 0 | 0 | 1 | 0 | N2 |
| 0 | 0 | 0 | 0 | 1 | 1 | N1 |
| 0 | 0 | 0 | 1 | 0 | 0 | N2 |
| 0 | 0 | 0 | 1 | 0 | 1 | N1 |
| 0 | 0 | 0 | 1 | 1 | 0 | N2 |
| 0 | 0 | 0 | 1 | 1 | 1 | N2 |
| 0 | 0 | 1 | 0 | 0 | 0 | N1 |
| 0 | 0 | 1 | 0 | 0 | 1 | N1 |
| 0 | 0 | 1 | 0 | 1 | 0 | N1 |
| 0 | 0 | 1 | 0 | 1 | 1 | N1 |
| 0 | 0 | 1 | 1 | 0 | 0 | N2 |
| 0 | 0 | 1 | 1 | 0 | 1 | N2 |
| 0 | 0 | 1 | 1 | 1 | 0 | N2 |
| 0 | 0 | 1 | 1 | 1 | 1 | N2 |
| 0 | 0 | 2 | 0 | 0 | 0 | F |
| 0 | 0 | 2 | 0 | 0 | 1 | F |
| 0 | 0 | 2 | 0 | 1 | 0 | F |
| 0 | 0 | 2 | 0 | 1 | 1 | F |
| 0 | 0 | 2 | 1 | 0 | 0 | T |
| 0 | 0 | 2 | 1 | 0 | 1 | T |
| 0 | 0 | 2 | 1 | 1 | 0 | T |
| 0 | 0 | 2 | 1 | 1 | 1 | T |

Then, referring to Table 7-2 which shows the determination of the charging power CP when the battery demand B_dmd has a score “0” and the energy demand E_dmd has a score “1” in the current window FW 1.

If the battery demand B_dmd and the energy demand E_dmd in the next window FW 2 both have a score “1”, the charging power CP will be “slow-2 charging”.

Otherwise, if the battery demand B_dmd and the energy demand E_dmd in the next window FW 2 have scores “1” and “0”, scores “0” and “1”, or scores “0” and “0”, the charging power CP will be “slow-1 charging”.

TABLE 7-2

| Input | | | | | | Output |
|---|---|---|---|---|---|---|
| FW 1 | | FW 2 | | FW 3 | | charging |
| B_dmd | E_dmd | B_dmd | E_dmd | B_dmd | E_dmd | power CP |
| 0 | 1 | 0 | 0 | 0 | 0 | S1 |
| 0 | 1 | 0 | 0 | 0 | 1 | S1 |
| 0 | 1 | 0 | 0 | 1 | 0 | S1 |
| 0 | 1 | 0 | 0 | 1 | 1 | S1 |
| 0 | 1 | 0 | 1 | 0 | 0 | S1 |
| 0 | 1 | 0 | 1 | 0 | 1 | S1 |
| 0 | 1 | 0 | 1 | 1 | 0 | S1 |
| 0 | 1 | 0 | 1 | 1 | 1 | S1 |
| 0 | 1 | 1 | 0 | 0 | 0 | S1 |
| 0 | 1 | 1 | 0 | 0 | 1 | S1 |
| 0 | 1 | 1 | 0 | 1 | 0 | S1 |
| 0 | 1 | 1 | 0 | 1 | 1 | S1 |
| 0 | 1 | 1 | 1 | 0 | 0 | S2 |
| 0 | 1 | 1 | 1 | 0 | 1 | S2 |
| 0 | 1 | 1 | 1 | 1 | 0 | S2 |
| 0 | 1 | 1 | 1 | 1 | 1 | S2 |

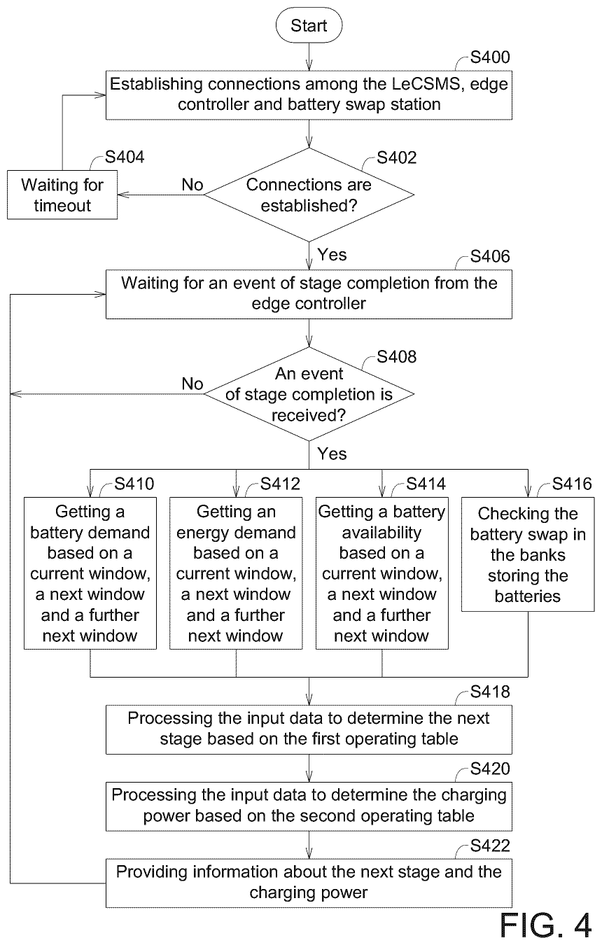

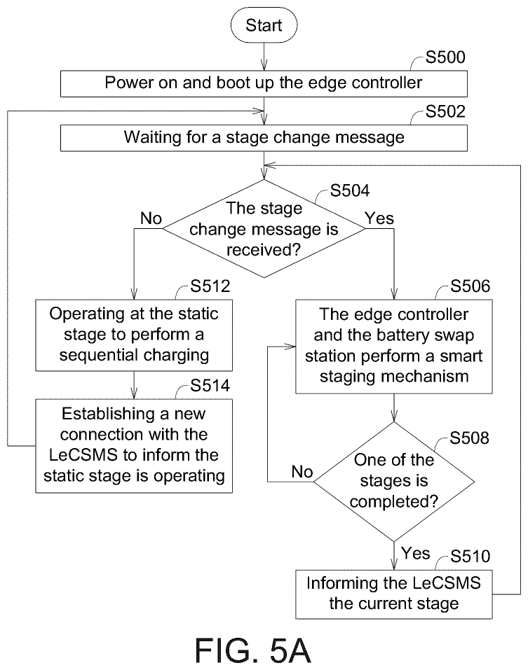

FIG. 4 is a flow diagram of a main flow of a battery charging method according to an embodiment of the present disclosure. In step S400, the LeCSMS module 1100 establishes a connection with the edge controller 1200, and the edge controller 1200 establishes a connection with the charging stations 101~103 of the battery swap station 1000 through the switch device 1300. Thereafter, in step S402, the battery swap station 1000 checks whether the charging stations 101~103 are connected with the edge controller 1200. If the charging stations 101~103 are not connected, step S404 is executed: the battery swap station 1000 waits for timeout. Then, goes to step S400. If the charging stations 101~103 are connected, step S406 is executed.

In step S406, the battery swap station 1000 waits for an event of stage completion from the edge controller 1200. The event of stage completion may indicate one of the stages S1, S2A, S2B, S3, S4, S5 and SI of the charging stations 101~103 is completed. In step S408, the battery swap station 1000 checks whether the event of stage completion is received. If the event of stage completion is not received, goes back to step S406. If the event of stage completion is received, steps S410, S412, S414 and S416 will be executed.

In step S410, the forecast processing engine 1201 of the edge controller 1200 gets the battery demand B_dmd from the demand forecast processor 1202, based on forecast windows. For example, the battery demand B_dmd is obtained based on a current window (e.g., FW 1), a next window (e.g., FW 2) and a further next window (e.g., FW 3).

In step S412, the forecast processing engine 1201 gets the energy demand E_dmd from the energy forecast processor 1205, based on the current window, the next window and the further next window. In step S414, the forecast processing engine 1201 gets the battery availability B_avl from the battery availability forecast processor 1203, based on the current window, the next window and the further next window.

In step S416, the forecast processing engine 1201 checks the battery swap B_swp to determine whether any swap(s) occurs in the banks storing the batteries B1a~B5a. Thereafter, step S418 is executed: the forecast processing engine 1201 processes the input data (i.e., the battery demand B_dmd, the energy demand E_dmd, the battery availability B_avl and the battery swap B_swp) which are obtained in steps S410, S412, S414 and S416, so as to determine the next stage NS for at least one of the charging stations 101~103 based on the first operating table.

Then, goes to step S420: the forecast processing engine 1201 processes the input data obtained in steps S410, S412, S414 and S416, so as to determine the charging power CP for at least one of the DC chargers 201~203 of the charging stations 101~103 based on the second operating table.

Then, goes to step S422: the forecast processing engine 1201 of the edge controller 1200 provides information about the next stage NS and the charging power CP to the LeCSMS module 1100 and the edge controller 1200. The information about the next stage NS may also include a notification of an immediate-change of the current stage CS. Then, goes back to step S406: waits for an event of stage completion from the edge controller 1200.

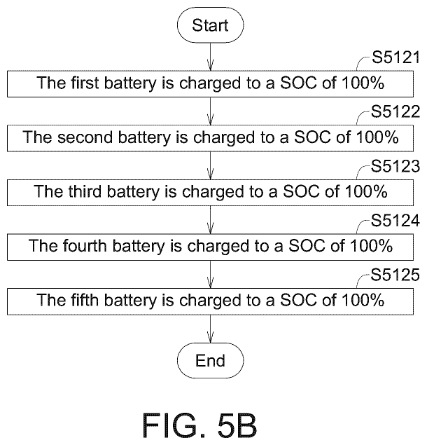

FIG. 5A is a flow diagram of a main flow of the smart staging mechanism in the battery charging method. In step S500, the edge controller 1200 is powered on and boots up. Thereafter, in step S502, the edge controller 1200 waits for a message indicating a change of the stages S1~S5 (referred to as a “stage change message”), from the LeCSMS module 1100. Then, goes to step S504: the edge controller 1200 checks whether the stage change message is received. If the stage change message is received, step S506 is executed: the edge controller 1200 in conjunction with the battery swap station 1000 performs a smart staging mechanism. Then, goes to step S508: the edge controller 1200 checks whether one of the stages S1~S5 is completed. That is, checking whether an event of stage completion is detected or received. If the event of stage completion is not detected, goes back to step S506. Otherwise, if the event of stage completion is detected, goes back to step S510: the edge controller 1200 informs the LeCSMS module 1100 the state of the smart staging mechanism, indicating the current stage CS during the present time period. Then, goes back to step S504 to check whether the stage change message is received.

On the other hand, if in step S504 the stage change message is NOT received and hence time-out, then goes to step S512: the charging stations 101~103 of the battery swap station 1000 operates at the stage S0 (i.e., the static stage) to perform a sequential charging, in which the batteries B1a~B5a will be charged sequentially with a constant charging power. Thereafter, goes to step S514: the edge controller 1200 establish a new connection with the LeCSMS module 1100, so as to inform the LeCSMS module 1100 that the battery swap station 1000 currently operates in the stage S0 performing the sequential charging with constant charging power. Then, goes back to step S502 to wait the stage change message.

FIG. 5B is a flow diagram of the stage S0 performed in step S512 of FIG. 5A. In the stage S0, a sequential charging is performed, in which the batteries B1a~B5a are charged sequentially with a constant charging power. As shown in FIG. 5B, in step S5121, the battery B1a is charged to a SOC of 100%. Then, goes to step S5122: change to charge a next battery, e.g., the battery B2a, until it is charged to a SOC of 100%. Then, goes to step S5123: change to charge the battery B3a to a SOC of 100%. Then, goes to step S5124: change to charge the battery B4a to a SOC of 100%. Finally, step S5125 is executed: change to charge the battery B5a to a SOC of 100%. In this manner, as one of the batteries B1a~B5a is charged to a SOC of 100%, then changes to charge a next one of the batteries B1a~B5a.

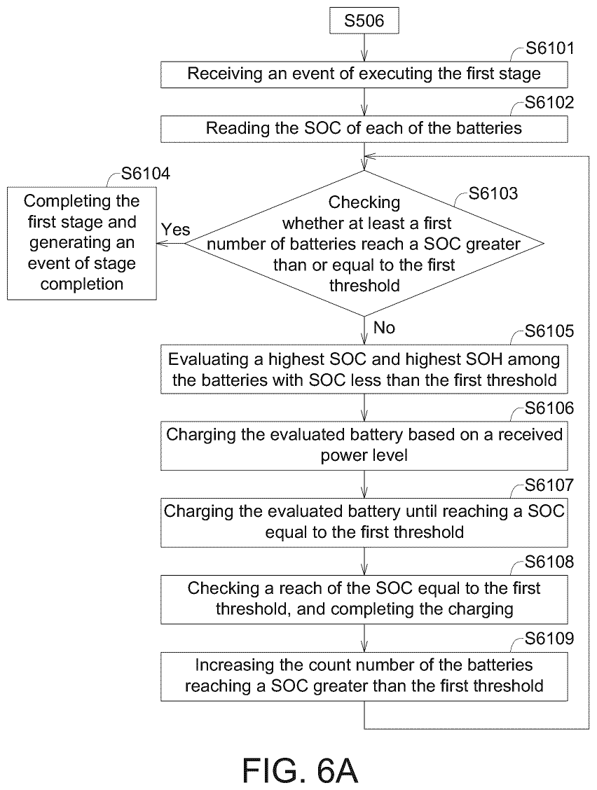

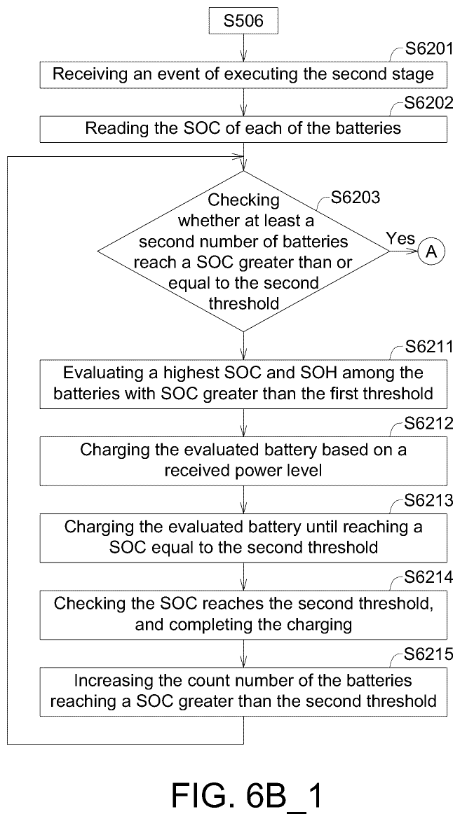

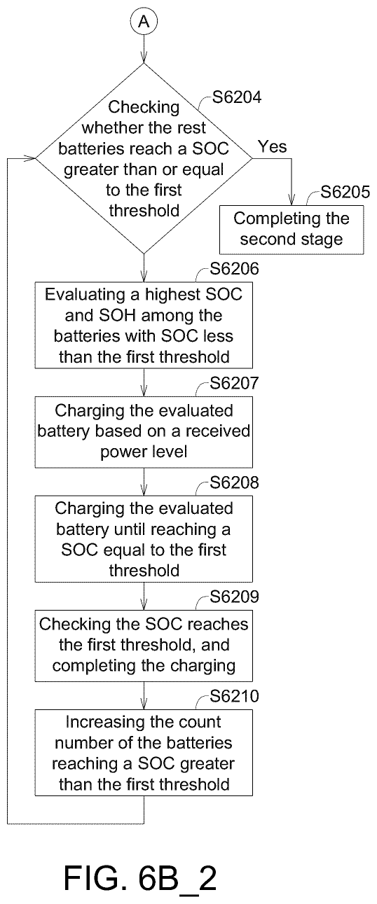

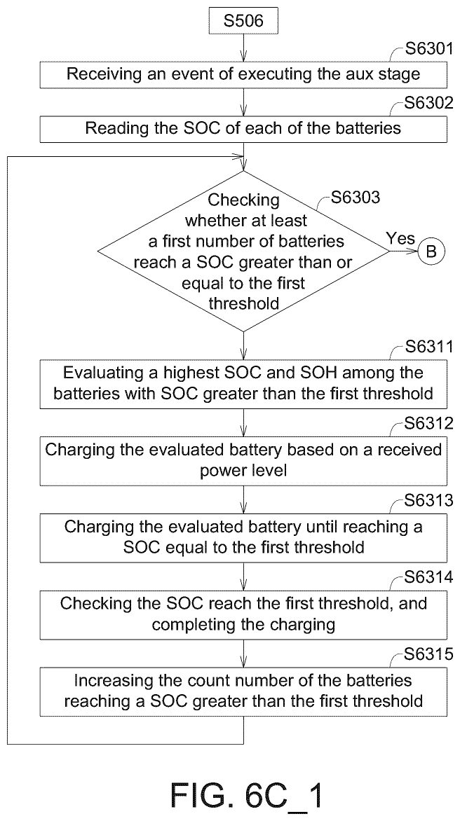

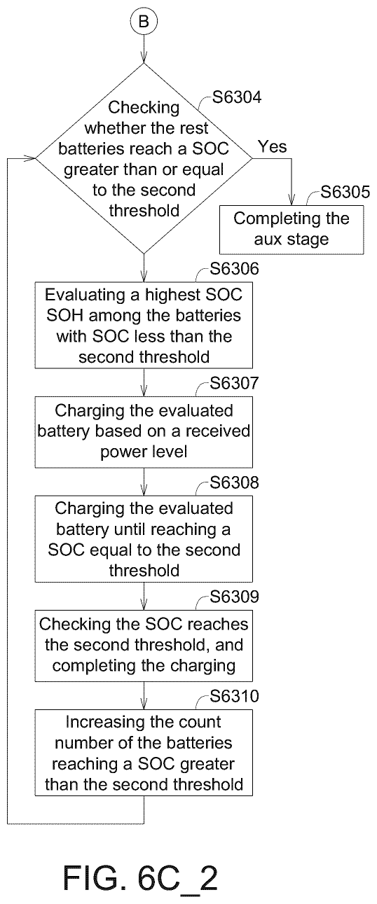

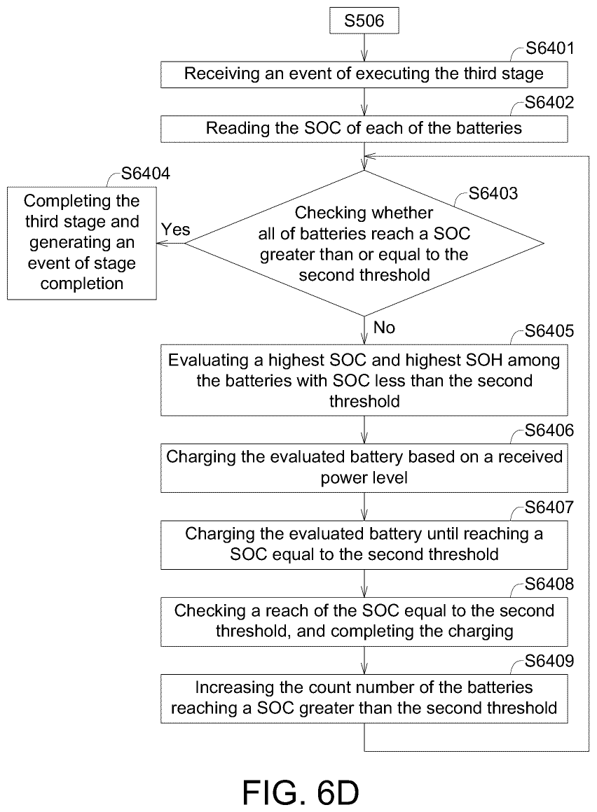

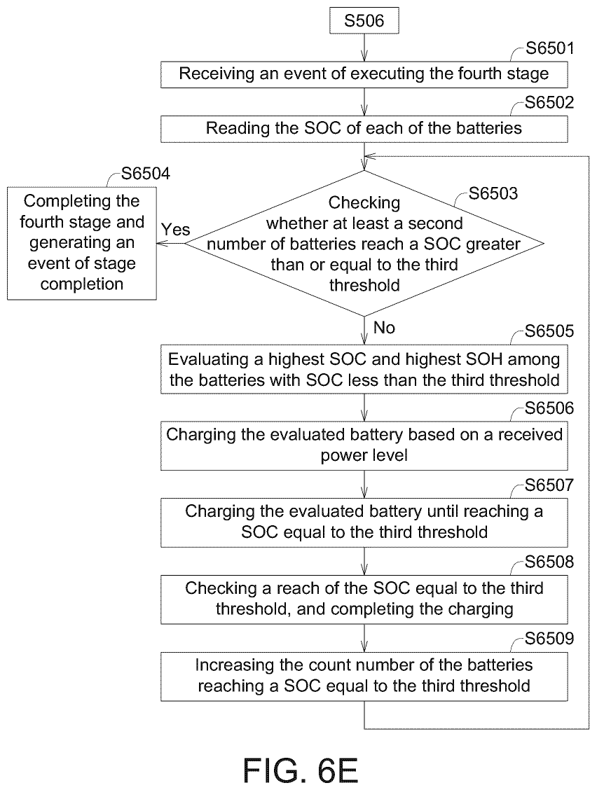

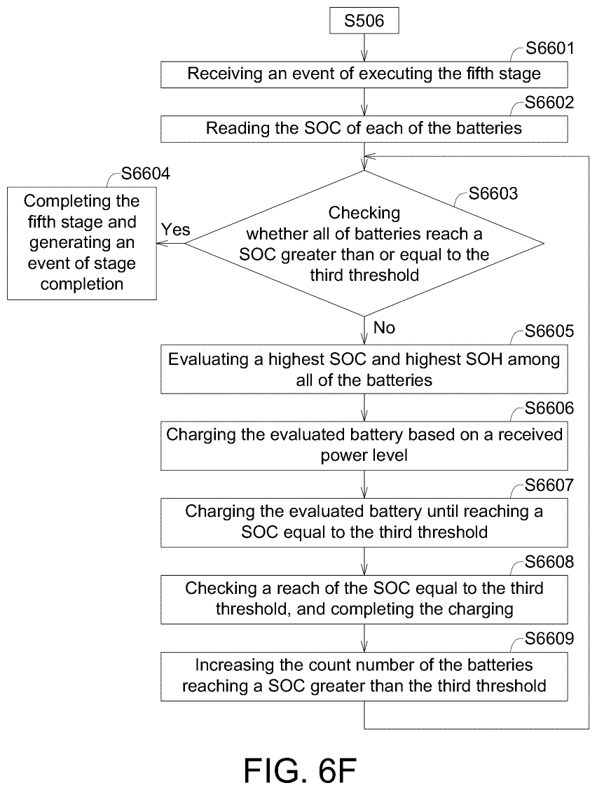

FIG. 6A is a flow diagram of the stage S1 in the smart staging mechanism. As shown in FIG. 6A, the stage S1 may start at step S6101, which is executed subsequent to the step S506 of FIG. 5A. In step S6101, an event of executing stage S1 is received. Then, goes to step S6102: the battery information processor 1204 of the edge controller 1200 reads the SOC of each of the batteries B1a~B5a. Then, goes to step S6103: the battery availability forecast processor 1203 of the edge controller 1200 analyzes the battery availability B_avl, checking whether at least a first number of batteries among the batteries B1a~B5a have a SOC greater than or equal to the first threshold. In one example, the first number is “3”, and the first threshold is “50%”. If the checking result of step S6103 is “yes”, indicating that, fewer batteries than the first number have a SOC greater than the first threshold, then goes to step S6104: completing the stage S1, and generating an event of stage completion.

On the other hand, if the checking result of step S6103 is “no”, indicating that, at least the first number of batteries have a SOC greater than the first threshold, then goes to step S6105: the battery availability forecast processor 1203 evaluates a highest SOC and highest SOH among the batteries with SOC less than the first threshold. Then, goes to step S6106: the charging station 101 turns on the DC charger 201 for charging the evaluated battery (which has the highest SOC and highest SOH) based on a received power level. Then, goes to step S6107: the DC charger 201 charges the evaluated battery based on the provided power level, until the evaluated batteries have a SOC equal to the first threshold.

Then, step S6108 is executed: checking the SOC equal to the first threshold is reached, and the DC charger 201 completes its charging. Then, goes to step S6109: increasing the count number of the batteries having a SOC greater than the first threshold. Then, goes back to step S6103: checking whether at least a first number of batteries have a SOC greater than or equal to the first threshold.

FIGS. 6B_1 and 6B_2 are flow diagrams of the stage S2A in the smart staging mechanism. The stage S2A may start at step S6201, which is executed subsequent to the step S506 of FIG. 5A. In step S6201, an event of executing stage S2A is received. Then, goes to step S6202: the battery information processor 1204 of the edge controller 1200 reads the SOC of each of the batteries B1a~B5a. Then, goes to step S6203: the battery availability forecast processor 1203 of the edge controller 1200 analyzes the battery availability B_avl, checking whether at least a second number of batteries among the batteries B1a~B5a have a SOC greater than or equal to the second threshold. In one example, the second number is “2”, and the second threshold is “80%”. If the checking result of step S6203 is “yes”, goes to step S6204: checking whether the rest batteries other than the at least a second number of batteries have a SOC greater than or equal to the first threshold (e.g., 50%). If the checking result of step S6204 is “yes”, goes to step S6205: completing the stage S2A, and generating an event of stage completion.

On the other hand, if the checking result of step S6204 is “no”, goes to step S6206: the battery availability forecast processor 1203 evaluates a highest SOC and highest SOH among the batteries with SOC less than the first threshold. Then, goes to step S6207: the charging station 101 turns on the DC charger 201 for charging the evaluated battery (which has the highest SOC and highest SOH) based on a received power level. Then, goes to step S6208: the DC charger 201 charges the evaluated battery based on the provided power level, until the evaluated batteries have a SOC equal to the first threshold. Then, goes to step S6209: checking the SOC equal to the first threshold is reached, and the DC charger 201 completes its charging. Then, goes to step S6210: increasing the count number of the batteries having a SOC equal to the first threshold.

Alternatively, if the checking result of step S6203 is “no”, goes to step S6211: the battery availability forecast processor 1203 evaluates a highest SOC and highest SOH among the batteries with SOC greater than the first threshold. Then, goes to step S6212: the charging station 101 turns on the DC charger 201 for charging the evaluated battery (which has the highest SOC and highest SOH) based on a received power level. Then, goes to step S6213: the DC charger 201 charges the evaluated battery based on the provided power level, until the evaluated batteries have a SOC equal to the second threshold. Then, goes to step S6214: checking the SOC equal to the second threshold is reached, and the DC charger 201 completes its charging. Then, goes to step S6215: increasing the count number of the batteries having a SOC equal to the second threshold.

FIGS. 6C_1 and 6C_2 are flow diagrams of the stage S2B in the smart staging mechanism. The stage S2B may start at step S6301, which is executed subsequent to the step S506 of FIG. 5A. In step S6301, an event of executing stage S2B is received. Then, goes to step S6302: reading the SOC of each of the batteries B1a~B5a. Then, goes to step S6303: analyzing the battery availability B_avl to check whether at least a first number (e.g., 3) of batteries among the batteries B1a~B5a have a SOC greater than or equal to the first threshold (e.g., 50%). If the checking result of step S6303 is “yes”, goes to step S6304: checking whether the rest batteries other than the at least a first number of batteries have a SOC greater than or equal to the second threshold (e.g., 80%). If the checking result of step S6304 is “yes”, goes to step S6305: completing the stage S2B, and generating an event of stage completion.

On the other hand, if the checking result of step S6304 is “no”, goes to step S6306: evaluating a highest SOC and highest SOH among the batteries with SOC less than the second threshold. Then, goes to step S6307: turning on the DC charger 201 for charging the evaluated battery (which has the highest SOC and highest SOH) based on a received power level. Then, goes to step S6308: charging the evaluated battery based on the provided power level, until the evaluated batteries have a SOC equal to the second threshold. Then, goes to step S6309: checking the SOC equal to the second threshold is reached, and completing the charging. Then, goes to step S6310: increasing the count number of the batteries having a SOC equal to the second threshold.

Alternatively, if the checking result of step S6303 is “no”, goes to step S6311: evaluating a highest SOC and highest SOH among the batteries with SOC less than the first threshold. Then, goes to step S6312: turning on the DC charger 201 for charging the evaluated battery based on a received power level. Then, goes to step S6313: charging the evaluated battery based on the provided power level, until the evaluated batteries have a SOC equal to the first threshold. Then, goes to step S6314: checking the SOC equal to the first threshold is reached, and completing the charging. Then, goes to step S6315: increasing the count number of the batteries having a SOC equal to the first threshold.

FIG. 6D is a flow diagram of the stage S3 in the smart staging mechanism. The steps of FIG. 6D may be similar to those of FIG. 6A. In FIG. 6A, the stage S1 is performed based on the first threshold (e.g., 50%) in steps S6103, S6105, S6107, S6108 and S6109. On the other hand, in FIG. 6D, the stage S3 is performed based on the second threshold (e.g., 80%) in steps S6403, S6405, S6407, S6408 and S6409.

The stage S3 may start at step S6401, which is executed subsequent to the step S506 of FIG. 5A. In step S6401, an event of executing stage S3 is received. Then, goes to step S6402: reading the SOC of each of the batteries B1a~B5a. Then, goes to step S6403: checking whether a third number of batteries among the batteries B1a~B5a have a SOC greater than or equal to the second threshold. In one example, the third number is “5” which is equal to the total number of the existing batteries B1a~B5a. If the checking result of step S6403 is “yes”, goes to step S6404: completing the stage S3, and generating an event of stage completion.

On the other hand, if the checking result of step S6403 is “no”, goes to step S6405: evaluating a highest SOC and highest SOH among the batteries with SOC less than the second threshold. Then, goes to step S6406: turning on the DC charger 201 for charging the evaluated battery based on a received power level. Then, goes to step S6407: charging the evaluated battery based on the provided power level, until the evaluated batteries have a SOC equal to the second threshold. Then, goes to step S6408: checking the SOC equal to the second threshold is reached, and completing the charging. Then, goes to step S6409: increasing the count number of the batteries having a SOC greater than the second threshold. Then, goes back to step S6403: checking whether a third number of batteries have a SOC greater than or equal to the second threshold.

FIG. 6E is a flow diagram of the stage S4 in the smart staging mechanism. The steps of FIG. 6E may be similar to those of FIG. 6A except that, the stage S4 is performed based on the third threshold (e.g., 100%) in steps S6503, S6507, S6508 and S6509 in FIG. 6E. The stage S4 may start at step S6501, which is executed subsequent to the step S506 of FIG. 5A. In step S6501, an event of executing stage S4 is received. Then, goes to step S6502: reading the SOC of each of the batteries B1a~B5a. Then, goes to step S6503: checking whether a second number (e.g., “2”) of batteries among the batteries B1a~B5a have a SOC greater than or equal to the third threshold. If the checking result of step S6503 is “yes”, goes to step S6504: completing the stage S4, and generating an event of stage completion.

On the other hand, if the checking result of step S6503 is “no”, goes to step S6505: evaluating a highest SOC and highest SOH among all the batteries B1a~B5a. Then, goes to step S6506: turning on the DC charger 201 for charging the evaluated battery based on a received power level. Then, goes to step S6507: charging the evaluated battery based on the provided power level, until the evaluated batteries have a SOC equal to the third threshold. Then, goes to step S6508: checking the SOC equal to the third threshold is reached, and completing the charging. Then, goes to step S6509: increasing the count number of the batteries having a SOC equal to the third threshold. Then, goes back to step S6503: checking whether a second number of batteries have a SOC greater than or equal to the third threshold.

FIG. 6F is a flow diagram of the stage S5 in the smart staging mechanism. The steps of FIG. 6F may be similar to those of FIG. 6E except that, in step S6603 of FIG. 6F the stage S5 is performed to check whether all the batteries B1a~B5a have a SOC equal to the third threshold. The stage S5 may start at step S6601, which is executed subsequent to the step S506 of FIG. 5A. In step S6601, an event of executing stage S5 is received. Then, goes to step S6602: reading the SOC of each of the batteries B1a~B5a. Then, goes to step S6603: checking whether all the batteries B1a~B5a have a SOC equal to the third threshold. If the checking result of step S6603 is “yes”, goes to step S6604: completing the stage S5, and generating an event of stage completion.

On the other hand, if the checking result of step S6603 is “no”, goes to step S6605: evaluating a highest SOC and highest SOH among all the batteries B1a~B5a. Then, goes to step S6606: turning on the DC charger 201 for charging the evaluated battery based on a received power level. Then, goes to step S6607: charging the evaluated battery based on the provided power level, until the evaluated batteries have a SOC equal to the third threshold. Then, goes to step S6608: checking the SOC equal to the third threshold is reached, and completing the charging. Then, goes to step S6609: increasing the count number of the batteries having a SOC equal to the third threshold. Then, goes back to step S6603: checking whether a second number of batteries have a SOC greater than or equal to the third threshold.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A battery charging system for charging a plurality of batteries, comprising:
a battery swap station, comprising:
a charging station, communicatively coupled to the batteries,
and
an edge controller, communicatively coupled to the battery swap station, and configured to perform an edge computation comprising:
detecting a battery swap in a plurality of banks storing the batteries;
forecasting a battery demand and an energy demand associated with the batteries and the charging station in a plurality of forecast windows;
controlling the charging station to operate at a plurality of stages, wherein the charging station transitions from a current stage to a next stage among the stages based on the battery swap, the battery demand and the energy demand; and
determining a charging power for charging the batteries corresponding to the stages.

2. The battery charging system of claim 1, further comprising:
a Cyber-Security-Management-System (LeCSMS) module, communicatively coupled to the edge controller through a Message-Queuing-Telemetry-Transport (MQTT) link, for performing a central computation aligned with the edge computation performed by the edge controller.

3. The battery charging system of claim 1, wherein the charging station transitions from the current stage to the next stage based on the battery demand and the energy demand which are forecasted in a current window, a next window and a further next window which are successive time periods among the forecast windows.

4. The battery charging system of claim 1, wherein the edge controller comprising:
a battery information processor, for obtaining a battery data of each of the batteries,
wherein the battery data comprises a state-of-charging (SOC) and a state-of-health (SOH) of each of the batteries.

5. The battery charging system of claim 4, wherein the edge controller further comprising:
a battery availability forecast processor, for retrieving the SOC in the battery data and obtaining a battery availability based on the SOC,
wherein the batteries comprise a plurality of available batteries having the SOC greater than a first threshold or a second threshold, and the battery availability indicates an average number of the available batteries.

6. The battery charging system of claim 5, wherein the edge controller further comprising:
a demand forecast processor, for obtaining the battery demand based on a ratio of the battery swap with respect to the battery availability.

7. The battery charging system of claim 6, wherein the edge controller further comprising:
an energy forecast processor, for obtaining the energy demand based on a ratio of a forecasted energy with respect to a total available energy of the charging station.

8. The battery charging system of claim 7, wherein the edge controller further comprising:
a forecast processing engine, for determining the charging power and the next stage in response to the battery swap, the battery availability, the battery demand, the energy demand and the current stage of the charging station.

9. The battery charging system of claim 1, wherein the charging power has a plurality of levels comprising a slow charging, a normal charging, a fast charging and a turbo charging.

10. The battery charging system of claim 1, wherein the stages for the charging station comprise a first stage which is completed when at least a first number of ones of the batteries have a state-of-charging (SOC) greater than a first threshold.

11. The battery charging system of claim 10, wherein the stages for the charging station further comprise a second stage which is completed when at least a second number of ones of the batteries have the SOC greater than a second threshold and rest batteries other than the second number of batteries have the SOC greater than the first threshold, wherein the second threshold is greater than the first threshold.

12. The battery charging system of claim 11, wherein the stages for the charging station further comprise an aux stage which is completed when at least the first number of batteries have the SOC greater than the first threshold and rest batteries other than the first number of batteries have the SOC greater than the second threshold.

13. The battery charging system of claim 12, wherein the stages for the charging station further comprise a third stage which is completed when all of the batteries have the SOC greater than the second threshold.

14. The battery charging system of claim 13, wherein the stages for the charging station further comprise a fourth stage which is completed when at least the second number of batteries have a full SOC that is equal to “100%”.

15. The battery charging system of claim 14, wherein the stages for the charging station further comprise a fifth stage which is completed when all of the batteries have the full SOC.

16. A battery charging method for charging a plurality of batteries which are communicatively coupled to a charging station, and the charging station is communicatively coupled to an edge controller, and the battery charging method comprising:
detecting a battery swap in a plurality of banks storing the batteries, by an edge computation of the edge controller;
forecasting a battery demand and an energy demand associated with the batteries and the charging station in a plurality of forecast windows, by the edge computation of the edge controller;
controlling the charging station to operate at a plurality of stages by the edge computation of the edge controller, wherein the charging station transitions from a current stage to a next stage among the stages based on the battery swap, the battery demand and the energy demand; and
determining a charging power for charging the batteries corresponding to the stages, by the edge computation of the edge controller.

17. The battery charging method of claim 16, wherein the edge controller is communicatively coupled to a Cyber-Security-Management-System (LeCSMS) module through a Message-Queuing-Telemetry-Transport (MQTT) link, and the battery charging method further comprising:
performing a central computation by the LeCSMS module, and the central computation is aligned with the edge computation of the edge controller.

18. The battery charging method of claim 16, wherein the charging station transitions from the current stage to the next stage based on the battery demand and the energy demand which are forecasted in a current window, a next window and a further next window which are successive time periods among the forecast windows.

19. The battery charging method of claim 16, further comprising:
obtaining a battery data of each of the batteries, by a battery information processor of the edge controller,
wherein the battery data comprises a state-of-charging (SOC) and a state-of-health (SOH) of each of the batteries.

20. The battery charging method of claim 19, further comprising:
retrieving the SOC in the battery data and obtaining a battery availability based on the SOC, by a battery availability forecast processor of the edge controller,
wherein the batteries comprise a plurality of available batteries having the SOC greater than a first threshold or a second threshold, and the battery availability indicates an average number of the available batteries.

21. The battery charging method of claim 20, further comprising:
obtaining the battery demand based on a ratio of the battery swap with respect to the battery availability, by a demand forecast processor of the edge controller.

22. The battery charging method of claim 21, further comprising:
obtaining the energy demand based on a ratio of a forecasted energy with respect to a total available energy of the charging station, by an energy forecast processor of the edge controller.

23. The battery charging method of claim 22, further comprising:
determining the charging power and the next stage in response to the battery swap, the battery availability, the battery demand, the energy demand and the current stage of the charging station, by a forecast processing engine of the edge controller.

24. The battery charging method of claim 16, wherein the charging power has a plurality of levels comprising a slow charging, a normal charging, a fast charging and a turbo charging.

25. The battery charging method of claim 16, wherein the stages for the charging station comprise a first stage, and the battery charging method further comprising:
completing the first stage when at least a first number of ones of the batteries have a state-of-charging (SOC) greater than a first threshold.

26. The battery charging method of claim 25, wherein the stages for the charging station further comprise a second stage, and the battery charging method further comprising:
completing the second stage when at least a second number of ones of the batteries have the SOC greater than a second threshold and rest batteries other than the second number of batteries have the SOC greater than the first threshold, wherein the second threshold is greater than the first threshold.

27. The battery charging method of claim 26, wherein the stages for the charging station further comprise an aux stage, and the battery charging method further comprising:
completing the aux stage when at least the first number of batteries have the SOC greater than the first threshold and rest batteries other than the first number of batteries have the SOC greater than the second threshold.

28. The battery charging method of claim 27, wherein the stages for the charging station further comprise a third stage, and the battery charging method further comprising:
completing the third stage when all of the batteries have the SOC greater than the second threshold.

29. The battery charging method of claim 28, wherein the stages for the charging station further comprise a fourth stage, and the battery charging method further comprising:
completing the fourth stage when at least the second number of batteries have a full SOC that is equal to “100%”.

30. The battery charging method of claim 29, wherein the stages for the charging station further comprise a fifth stage, and the battery charging method further comprising:
completing the fifth stage when all of the batteries have the full SOC.
